(19) United States
(12) Patent Application Publication
(10) Pub. No.: US 2026/0089806 A1
(43) Pub. Date: Mar. 26, 2026

(54) Annular Flow Electric Particle Heater

(71) Applicant: National Technology & Engineering Solutions of Sandia, LLC, Albuquerque, NM (US)

(72) Inventors: Shaker S. M. Abdullah Alaqel, Albuquerque, NM (US); Jeremy N. I. Sment, Albuquerque, NM (US); Hendrik F. Laubscher, Albuquerque, NM (US); Luke P. McLaughlin, Rio Rancho, NM (US); Nathaniel R. Schroeder, Albuquerque, NM (US)

(21) Appl. No.: 19/332,889

(22) Filed: Sep. 18, 2025

Related U.S. Application Data
(60) Provisional application No. 63/698,925, filed on Sep. 25, 2024.

(51) Int. Cl. H05B 3/44; H05B 1/02

(52) U.S. Cl. CPC H05B 3/44; H05B 1/0283; H05B 2203/005

(57) ABSTRACT

An electric particle heater for use in with moving particle thermal energy storage systems includes one of more vertically arranged electric heater rods, and a particle feed, distribution, and collection system directing a volume of particles axially in parallel flow along the heater rods. Each heating rod includes a containment tube to manage the geometry of the falling particles and create a uniform annular curtain of particles surrounding each heating rod. A flow control apparatus enables uniform particle velocity across all heating rods to be established and controlled to optimize heat transfer from each of the heating rods. A heating control apparatus allows input power control to the heating rods to optimize heating rod temperature along their length.

### CROSS-REFERENCE TO RELATED APPLICATIONS

The present application claims the benefit of U.S. Provisional Application Ser. No. 63/698,925, filed Sep. 25, 2024, the entire teachings of which application is hereby incorporated herein by reference.

### GOVERNMENT INTEREST STATEMENT

This invention was made with Government support under Contract No. DE-NA0003525 awarded by the United States Department of Energy/National Nuclear Security Administration. The U.S. Government has certain rights in the invention.

### FIELD OF THE INVENTION

The present disclosure is generally directed to particle-based energy transfer systems, and more particularly to a high-temperature, electric particle heater.

### BACKGROUND OF THE INVENTION

Concentrated solar power (CSP) stands out among various clean and renewable energy options as it offers a distinct advantage over solar photovoltaic (PV) systems: cost-effective long duration thermal energy storage. This feature addresses a key limitation of solar PV systems by reducing the need for fossil fuel peaking plants to rapidly increase their output during afternoons when solar PV output declines. By utilizing solid particles as the heat-capturing and energy storage medium, particle-based concentrating solar power (PBCSP) systems have emerged as one of the most promising alternatives within the CSP domain, and for grid scale energy storage applications.

PBCSP systems harness solar energy by concentrating sunlight onto a thermal receiver where solid particles, such as sand, absorb and store the heat. This stored thermal energy can then be utilized to generate electricity or provide heat even when sunlight is not available, such as during nighttime or cloudy conditions. This characteristic makes PBCSP an attractive technology for providing reliable and dispatchable power, ensuring a stable and continuous energy supply.

A PBCSP system comprises several essential components, including the particle heating receiver (PHR), high-temperature thermal energy storage (HTTES) bin, particle-to-fluid heat exchanger (PFHX), low-temperature thermal energy storage (LTTES) bin, and particle lift system (PLS). The incorporation of thermal energy storage in CSP systems is gaining traction due to its positive economic impacts, such as a reduced Levelized Cost of Energy (LCOE), enhanced dispatchability, and improved capacity factor. The use of solid particles as a working and storage medium in CSP systems addresses various challenges associated with molten salts, such as stability limitations, corrosion, the requirement for heat tracing, and operating temperature.

By utilizing solid particles, PBCSP overcomes these issues, offering improved thermal stability, reduced corrosion concerns, and the ability to operate at higher temperatures. The solid particles efficiently capture and store heat, enabling effective energy transfer and storage throughout the CSP system. This novel approach enhances the overall performance and reliability of the system while providing economic benefits in terms of lower costs and improved operational flexibility.

However, while the use of solid particles is advantageous in PBCSP systems, this technology is considered a viable and energy-efficient solution, particularly for regions with high levels of direct normal irradiance (DNI). Recently, the integration of PV in particle-based thermal energy storage systems is growing rapidly. By replacing the heliostat field with PV and PHR with a particle electric heater, several benefits can be achieved. PV fields generally require less land per megawatt of electricity compared to CSP plants. While PV systems directly convert sunlight into electricity, CSP plants convert solar energy to heat then to electricity. Further, unlike CSP plants, PV systems do not necessarily depend on high DNI levels to achieve economic benefits and are capable of power generation during times of moderate to low global horizontal irradiance (GHI). This makes a PV installation much more geographically flexible compared to other renewable energy technologies like CSP, hydro-electric and wind.

The operations and maintenance cost of PV systems at utility scale in terms of unit cost/kWh-electric is significantly lower, compared to electricity generated by a CSP facility. Therefore, the use of PV technology to electrically heat solid particles offers an attractive combination of technical and economic benefits. By leveraging the advantages of both PV systems and particle heating, this approach can provide cost-effective harnessing of solar energy and low-cost, long-duration energy storage.

However, for the combination to become practically viable, cost-effective particle heater is needed. Reliable high-temperature particle heaters are still commercially unavailable, for the application of heating granular particles to high temperature. Existing particle heater designs are still in the proof-of-concept phase. Typical high-temperature particle heaters make use of an array of cartridge heaters positioned perpendicular to the particle flow path. This arrangement resembles the particle flow characteristic in the shell-and-tube moving packed bed heat exchanger. Although a variety of design variants have been attempted, such as the addition of fins and the like, such particle heaters are typically not cost-effective and serve primarily as “proof of concept”models.

H. Takeuchi, “Particles flow pattern and local heat transfer around tube in moving bed,” AIChE journal, vol. 42, no. 6, pp. 1621-1626, 1996, used X-ray video films to visualize the flow of particles around a circular tube of several types of tube arrangements including a single tube, a single row of tubes, two rows of tubes, and three rows of tubes; staggered formation was used in the last two cases. The author found that the flow pattern and thus the local heat transfer coefficient depends greatly on the tube arrangement. Three zones were observed around the tube of staggered banks, namely the stagnant zone on top of the tube, a void zone below the tube, and a moving bed region along both sides of the tube. The size of the stagnant zone is affected by the tube pitch, as the pitch increases the stagnant zone flattens; on the other hand, the particle velocity has no effect on the stagnant zone. The existence of the stagnant and void zones has a negative effect on the heat exchange process. The local heat transfer coefficient was found to be between 25 and 120 W/m²K for the two-row arrangement when particles velocities range from 0.4 to 6.7 mm/s. This stagnation zone results in an element hot spot which makes the element prone to premature failure and limits the maximum temperature particles can be heated to.

Bartsch, P. and Zunft, S., 2019, “Granular flow around the horizontal tubes of a particle heat exchanger: DEM-simulation and experimental validation,” Solar Energy, 182, pp.48-56, developed a numerical model using the discrete element method (DEM) to investigate the granular flow field around the horizontal tubes of the adapted design; they compared the simulation results with the experimental data (measured by using particle image velocimetry). The simulation results deviate from the experiments at the void zone; and agree well at the stagnation zone and to some extent with the rest of the flow field.

H. Al-Ansary et al., “Experimental study of a sand-air heat exchanger for use with a high-temperature solar gas turbine system,” Journal of solar energy engineering, vol. 134, no. 4, 2012, studied the heat transfer characteristics of sand bulk flow in a sand-air heat exchanger which was intended to be used in the CSP facility at KSU. The tested heat exchanger was made of a transparent polymer box which included a tube bank consisting of eight tubes arranged in three rows in a staggered formation. The tubes, either bare or finned, were made out of carbon steel and electrically heated by heater cartridges. Experiments were conducted on silica sand and olivine sand with two parameters being changed namely, the power input (100 W to 350 W) and sand velocities (1 and 3 mm/s). The authors found that heat transfer coefficient was slightly affected by the sand type, with olivine a little higher than silica. The sand velocity was found to have a positive and significant effect on the heat transfer coefficient, and the reported values for bare and finned tubes were found in the range of 80-160 W/m²K, with bare tubes higher than finned tubes. Nguyen et al. [4] continued the previous work by testing five particulate materials; those are fracking sand, Atlanta industrial sand, Riyadh white sand, small and large proppants. The authors investigated the effect of higher particles velocities on the heat transfer coefficient; the velocities used were 3, 5 and 10 mm/s. The results showed that the particles velocity had a great effect on enhancing the heat transfer coefficient.

In view of the above, it would obviously be desirable to be able to eliminate stagnant/void zones in a particle heating apparatus to improve heat transfer efficiency in particle heat exchangers. A parallel flow arrangement where particle slide vertically along cylindrical rods at a relatively high velocity could enhance heat exchange process, optimize rods usage, and provide sufficient heat removal which in turns reduces rod failures due to overheating. Other features and advantages will be made apparent from the present specification. The teachings disclosed extend to those embodiments that fall within the scope of the claims, regardless of whether they accomplish one or more of the aforementioned needs.

### SUMMARY OF THE INVENTION

The present disclosure relates to high-temperature particle-based electric heaters. Electric particle heaters are required to convert electricity generated by (PV), wind, and hdyro technologies to heat for pairing with moving particle bed thermal energy storage (MPBTES) technologies. An improved particle heater design disclosed herein 1) reduces number of heating rods required, 2) improves heat transfer, and 3) removes vulnerable particle-free wake zones (present in traditional heater designs) which limit the maximum particle heating temperature and cause premature failure. The improved design aligns resistive heater assemblies (cartridges) parallel to a packed bed particle flow rather than perpendicularly aligned to particle flow in the traditional design. Heater rods are placed within containment tubes to create annular particle flow regions surrounding the heater rods and divide the bulk particle flow. The parallel element alignment and annular flow paths improve heat transfer by reducing the time for heat penetration, increasing particle velocity, and increasing the contact surface area between the heater rod and particles. Further, the parallel arrangement and annular flow paths ensure uniform particle distribution around the surface of the element, removing the particle-free zones present in the perpendicular heater arrangement. This novel design provides improvement in particle-to-heating rod contact and heat transfer coefficient which will 1) reduce the number of heater elements needed to achieve a heater power rating by enabling higher element watt densities, 2) reduce the heater footrpint via increased watt densities, and 3) increase the operational life of the heaters by reducing hot-spot degradation. Together, the improved design results in a cost-effective heater design.

Accordingly, the present invention, in any of the embodiments described herein, may provide one or more of the following advantages:

It is an advantage of an embodiment to provide a particle heater including an elongate conduit with an inlet and an outlet, an elongate heating rod disposed within the conduit, the space between an exterior surface of the heating rod and an interior surface of the conduit defining an annular flow path extending between the inlet and the outlet. Particles are supplied by a feed apparatus to the inlet and uniformly distributed about the inlet annular flow path. Particles are gravity-driven through the annular flow path creating a curtain of particles of uniform thickness falling axially along the exterior surface of the heating rod toward the outlet. A discharge apparatus receives particles from the outlet of the annular flow path and manages the particle flow.

It is an advantage of an embodiment to provide a particle heater including a vertically oriented conduit with a heating rod disposed therein to create an annular flow path between an inlet and an outlet. Particles are supplied to the inlet and distributed into a uniformly thick bed of packed particles flowing downwardly along the heating rod in the annular flow path. The heating rod includes a controller managing energy input to the heating rod to maintain a desired temperature of the heating rod. Energy input to the heating rod may be varied depending on the length of the heating rod to maintain a desired heating rod temperature along its length despite heat transfer variations arising from increasing particle temperature.

It is an advantage of an embodiment to provide a thermal system including a particle heater apparatus with an intake receiving particles from a supply system. The intake includes a feed apparatus that distributes particles to a plurality of particle heaters, each having a vertically oriented conduit with a heating rod disposed therein to create an annular flow path between an inlet and an outlet. The feed apparatus also uniformly distributes particles about the inlet annular flow path of each particle heater. Particles are gravity-driven through each annular flow path creating a packed bed of particles of uniform thickness flowing axially along the exterior surface of each heating rod toward the outlet. A discharge apparatus receives particles from the outlet of each annular flow path and manages the particle flow rate. The discharge apparatus may include a flow control apparatus allowing simultaneous control of the particle flow rate through the annular flow path of the plurality of particle heaters.

It is an advantage of an embodiment to provide a method of heating solid particles for use in a thermal process that includes delivering a flow of particles to a particle heater, the heater having an elongate conduit with a heating rod disposed therein to create an annular flow path between an inlet and an outlet, wherein the particles are uniformly distributed around the annular flow patch. Input energy is delivered to the heating rod to heat particles as they are gravity-driven through the annular flow patch from the inlet to the outlet. The particle flow rate and/or input energy may be managed to maintain the heating rod at a desired temperature and maximize heat transfer to the particles.

Other features and advantages of the present invention will be apparent from the following more detailed description of the preferred embodiment, taken in conjunction with the accompanying drawings which illustrate, by way of example, the principles of the invention.

### BRIEF DESCRIPTION OF DRAWINGS

The advantages of this invention will be apparent upon consideration of the following detailed disclosure of the invention, especially when taken in conjunction with the accompanying drawings wherein:

FIG. 1A illustrates a velocity distribution of granular flow around a single circular tube as known in the prior art;

FIG. 1B illustrates a velocity distribution of granular flow around two rows of circular tubes as known in the prior art;

FIG. 2A shows contour plots of granular flow speed in particle image velocimetry measurement of prior art applications of particle flow transverse to tubes;

FIG. 2B shows contour plots of discrete element simulation method of prior art applications of particle flow transverse to tubes;

FIG. 3A shows a general design of a vertical particle heater assembly including an individual particle heater (FIG. 3B) according to an embodiment of the disclosure;

FIG. 3B shows a general design of an individual particle heater according to an embodiment of the disclosure;

FIG. 3C shows a general design of a vertical particle heater assembly including a particle intake and feeding apparatus according to an embodiment of the disclosure;

FIG. 3D shows a general design of a vertical particle heater assembly including a particle discharge apparatus according to an embodiment of the disclosure;

FIG. 4 shows an assembled and exploded view of a particle intake and feeding apparatus according to an embodiment of the disclosure;

FIG. 5A shows a top view of an exemplar tube sheet used in the particle intake and feeding apparatus according to an embodiment of the disclosure;

FIG. 5B shows a bottom view of an exemplar tube sheet used in the particle intake and feeding apparatus according to an embodiment of the disclosure;

FIG. 6A illustrates a particle heater used in the particle heating apparatus according to an embodiment of the disclosure;

FIG. 6B is an exploded view of the particle heater of FIG. 6A;

FIG. 6C is a cross-sectional view of the particle heater of FIG. 6A;

FIG. 6D is a partial exploded view of a portion of FIG. 6C;

FIG. 7 shows a particle heater interface with a tube sheet in the feeding apparatus;

FIG. 8 provides a graph comparing peak heater surface temperature versus particle outlet temperature for the disclosed particle heater;

FIG. 9 shows an assembled and exploded view of a particle discharge apparatus;

FIG. 10A shows an embodiment of a particle flow control arrangement used in the discharge apparatus;

FIG. 10B shows an alternative view of the embodiment of a particle flow control arrangement shown in FIG. 10A;

FIG. 11 illustrates an embodiment of a temperature monitoring system for use in controlling the particle heating system; and

FIG. 12 illustrates an exemplar process system incorporating an embodiment of the particle heating system.

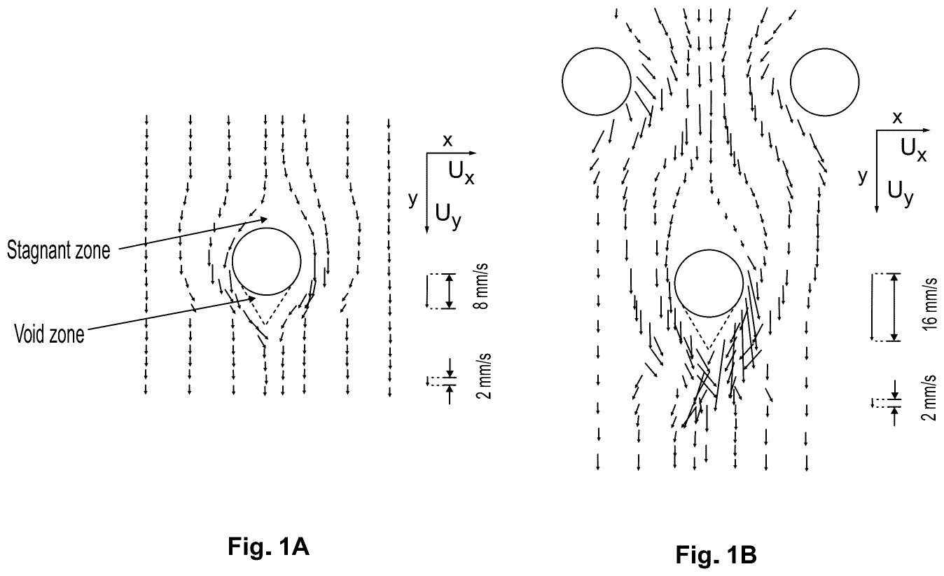

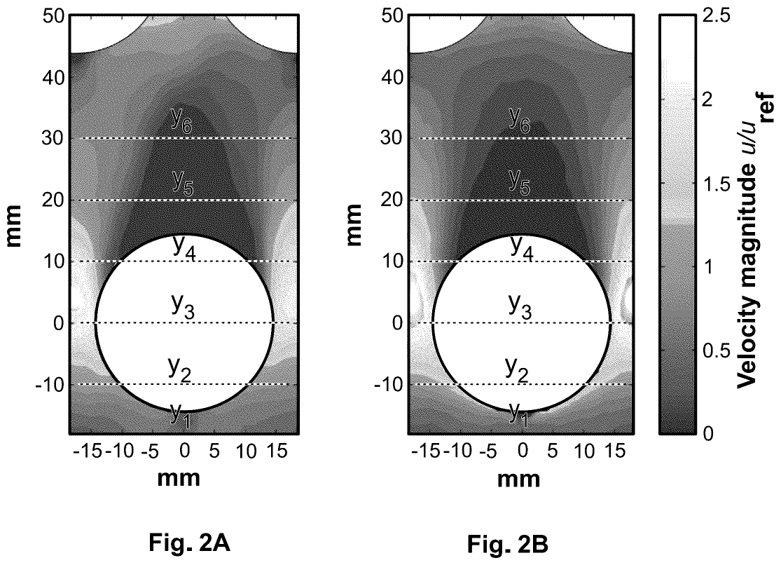

Wherever possible, the same reference numbers will be used throughout the drawings to represent the same parts.

### DETAILED DESCRIPTION OF THE INVENTION

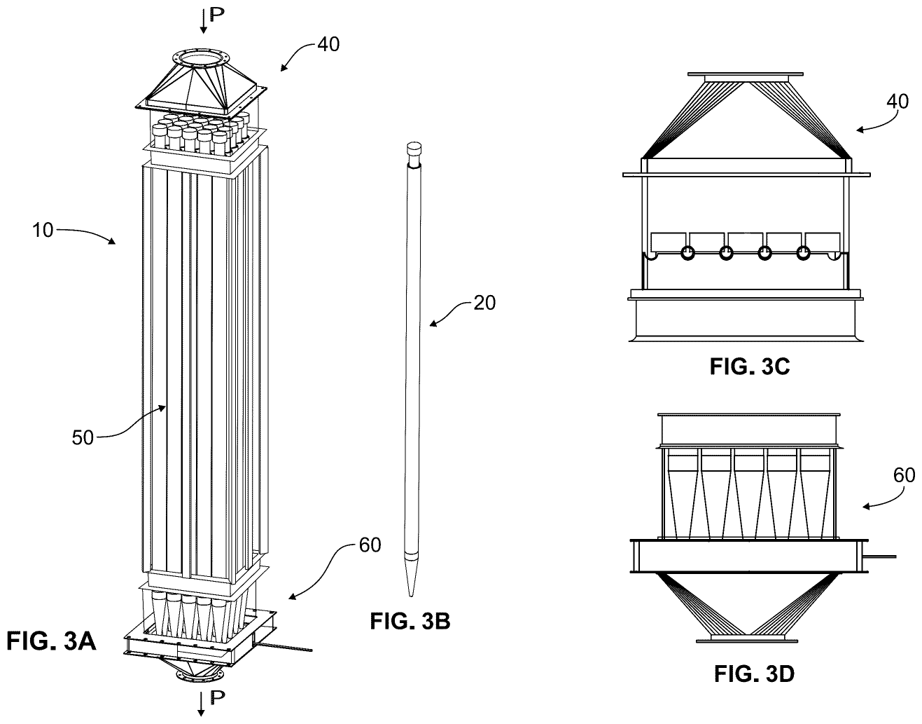

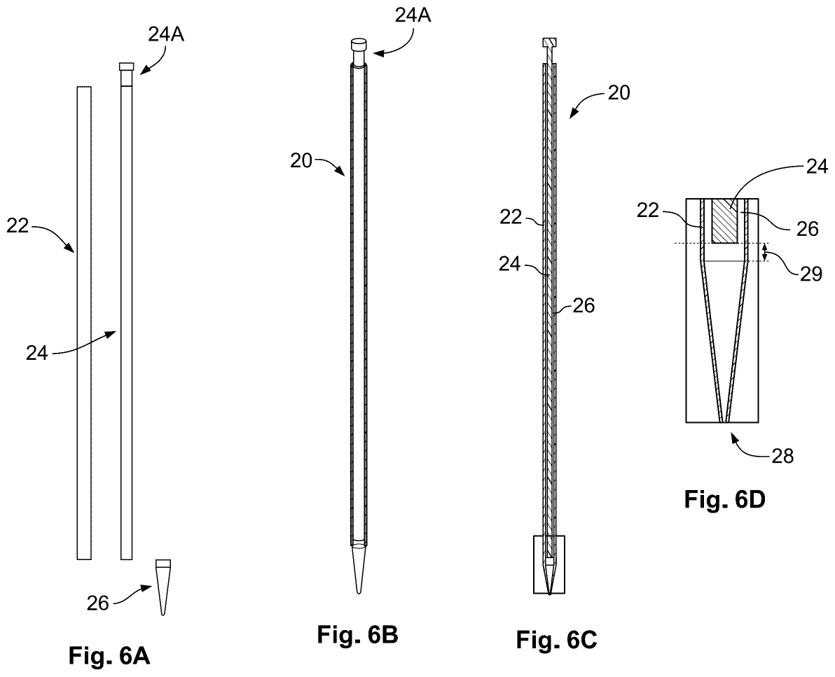

FIG. 3A-3D show a general design of a vertical heater assembly 10 where solid particles are directed axially (direction “P”) through the heart assembly. Within the assembly, particles are distributed for flow through a plurality of heaters 20, each having a conduit 22 surrounding an electric heating rod 24 (as shown in FIGS. 6A-6D). After passing through the plurality of heaters, particle flow is consolidated and discharged from the heater assembly. The solid particles may comprise sand, ceramics, or any other particle media suitable for operation at the anticipated process temperatures and capably of movement through the heater assembly by gravity.

In the illustrated embodiment, the heaters 20 are generally vertically oriented and the particles are allowed to fall by gravity in an annular space 26 separating the exterior surface of the heating rod 24 from the interior surface of the conduit 22 so that the particles travel alongside the heating rods 24 in a parallel flow for the length of the heating rods in an annular flow path 28. The heater assembly 10 comprises three main sections: a particle feeding assembly 40, the particle heaters 20 which form a heating core 50, and a particle discharge assembly 60. The particle feeding apparatus 40 delivers and uniformly distributes solid particles across the array of heaters 20 comprising the heating core 50 of the heater assembly 10. The heating core 50 comprises an array of particle heaters 20 each having an electric heating rod 24 axially disposed within an annular guide tube or conduit 22 wherein the electric heating rods deliver heat to a gravity driven particle bed though the annular flow path 28. The particle discharge assembly 60 is responsible for controlling particle flow rate, particle residence time, and particle outlet temperature, the following sections give a detail description of each subsystem assembly.

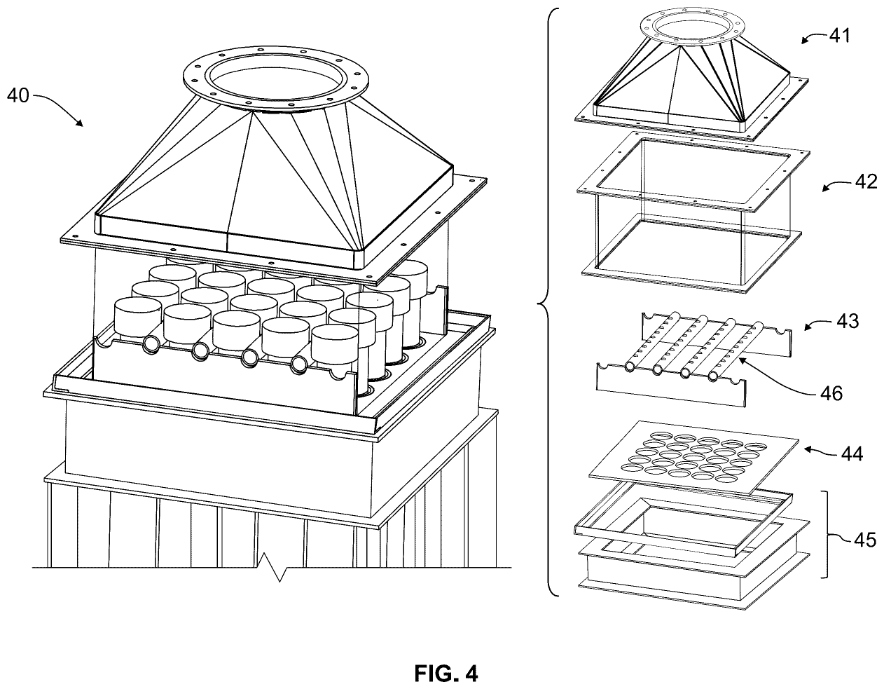

FIG. 4 shows an exploded view of the particle feeding assembly 40. As can be seen, the assembly comprises an inlet feeding cone 41, an inlet feeding header 42, heating rod support 43, inlet tube sheet 44, and particle feeding support 45. The inlet feeding cone 41 is responsible for providing an adequate particle inventory from a particle supply system to keep energized electric heating rods fully immersed in a flow of moving particles to avoid overheating electric heating rods. It is crucial to maintain uniform particle flow conditions through the heating core 50 to maximize heating rod service life.

The inlet feeding header 42 houses an unheated portion 24A of the heating rods 24. Particle movement velocity in the inlet feeding header 42 is comparatively low and non-optimal for heat transfer from the heating rods. The unheated portions provide a structure for supporting the heating rods within the heating core, allows connection of electrical conductors which power the elements, and accommodates the sub-optimal heat transfer conditions in this region of the particle heating system 10. It is imperative to include unheated segment to prevent overheating the heating rod lead wires since this area experiences low particle velocity, i.e., slow heat removal process.

The inlet feeding header 42 also houses and supports the heating rod support 43. In the exemplar design, the heating rods 24 are suspended from the top and extend freely inside the conduits 22. The heating rod support 43 employs an array of horizontal supports 46. The horizontal support 46 are preferably hollow to house the electrical feed conductors for the heating rods and protect the conductors from particle abrasion. The horizontal supports 46 may extend outside of the inlet feeding header 42 to provide access to the interior space to permit the insertion of the heating rods conductors. The interface between the horizontal supports 46 and the unheated portion 24A of the heating rods should be oriented and/or shielded to minimize particle flow abrasion on the conductors.

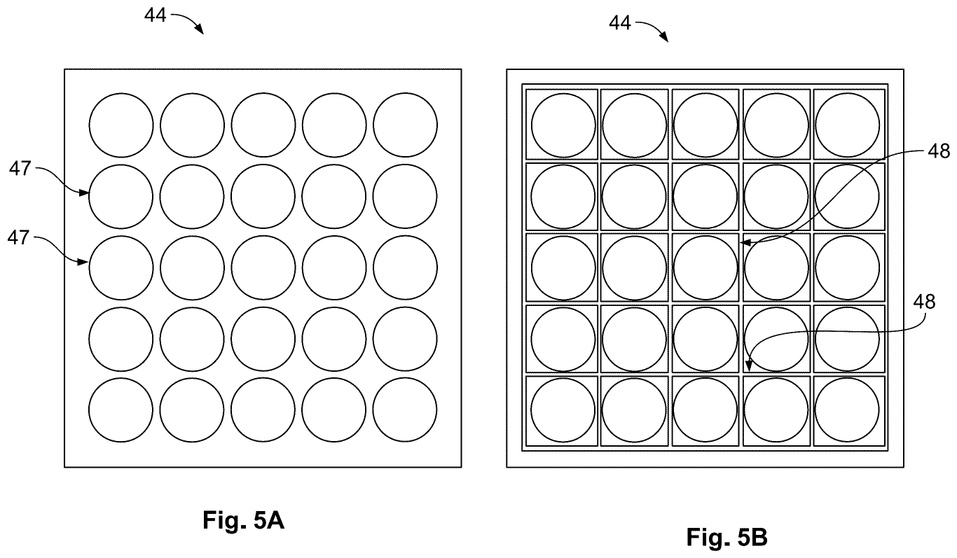

The tube sheet 44 provides support for the plurality of conduits 22 of the heating core 50. The tube sheet 44 includes a plurality of openings 47 through which the particle heaters 20 may pass, as shown in FIG. 5A. The openings are sized to receive the conduits and support the conduits which are fixed to the tube sheet by welding or other mechanical means. The tube sheet 44 thus defines the lower boundary for particles in the particle feeding system 40. Particle flow below the tube sheet is limited to flow though the annular flow paths of the conduits. The material, thickness, and reinforcement of the sheet shall be carefully considered to provide the required design integrity. As an example, but not limited to, the tube sheet 44 can employ multiple stiffening ribs 48 to improve the sheet integrity, as shown in FIG. 5B.

FIG. 6A shows a particle heater 20 according to an embodiment of the disclosure. FIG. 6B shows an exploded view of the particle heater 20. As can be seen in FIG. 6A, the heater 20 includes a heating rod 24 surrounded by a conduit 22. In this exemplary embodiment, the heating rod 24 is a single physical heating element. In other embodiments, the heating rod 24 may include multiple discrete heating elements electrically connected and positioned inside conduit 22.

The number of heating elements provided in each heating rod 24 depends on the scale and intended application of the heater system. The heating rod may include multiple heating elements to better enable variation of heat input along the length of the heating rod 24 to match with the increasing particle temperature as particles travel downward though the annular flow path. The heating rods 22 are suspended from the top by the heating rod support 43. Heating rods 24 are allowed to expand downward freely within the conduits 22. To accommodate thermal growth of the heating rods, each conduit 22 length is established so that the maximum thermal growth of the heating rod will not extend the heating rod end below the cylindrical conduit 22. Each conduit 22 includes a tapered discharge cone 26 disposed at the lowermost end. The discharge cone 26 includes a discharge opening 28. The discharge opening is preferably sized to match the flow area of the annular flow path allowing for more consistent control of particle flow. By providing a discharge cone for each conduit and its associated annular flow path, particle flow may be managed for each particle heater 20 to minimize variations in localized particle flow across the entire heating core compared to systems utilizing a single flow control mechanism at the heating system discharge similar to mass flow systems used in known perpendicular particle heaters.

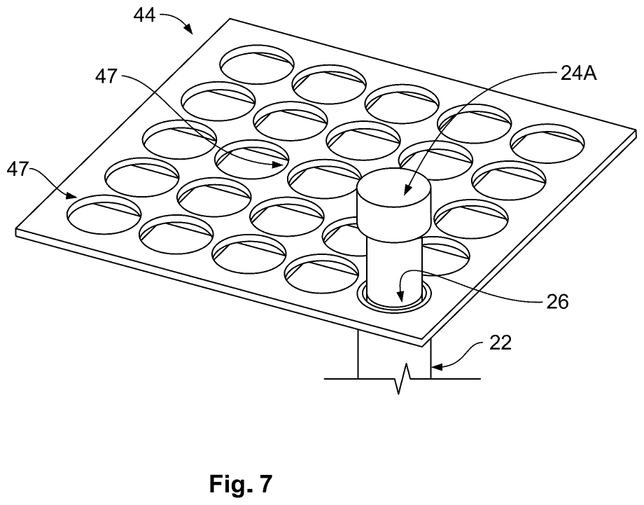

The unheated portion 24A of heating rod 24 extends upwardly above the tube sheet 44. The heated portion of the heating rod 24 is positioined inside of the conduit 22 and extends downwardly through the conduit toward it slower end, as shown in FIG. 7.

The benefits of orienting the heating rods in a parallel-to-path of the particles allows the particle bed to move axially long the length of the heating rod and provides the following benefits:
Sufficient heat transfer proces resulting in heating rod life.
Enhanced particle-to-element contact, high-temperature zones (hot spots) on the heating rods are eliminated making element overheating unlikely.
More compact footprint. Electric heating elements have a limited wattage density. Using longer rods allows for higher wattage per heating element therey requiring fewer elements for a given energy dissipation.
Eliminates the need of a large, total flow discharge cone. The use of individual small cones on each heater conduit assembly provides a uniform mass flow pattern around each of the heating rods.

To demonstrate the aforementioned advantages, parallel and perpendicular heater designs were modeled to compare the thermal performance of each design. Performance of the perpendicular heater design was modeled with 1) ANSYS Fluent Computational Fluid Dynamics (CFD), treating the particle flow as a dense-phase fluid with properties mimicking that of solid particle flow (i.e., pseudo fluid), and 2) ANSYS Fluent Discrete Element Modeling (DEM). A 400 kW heater was considered for the analysis. Particle flow rate was varied from 2-25 kg/s and targeted particle outlet temperature varied from 600-900° C.

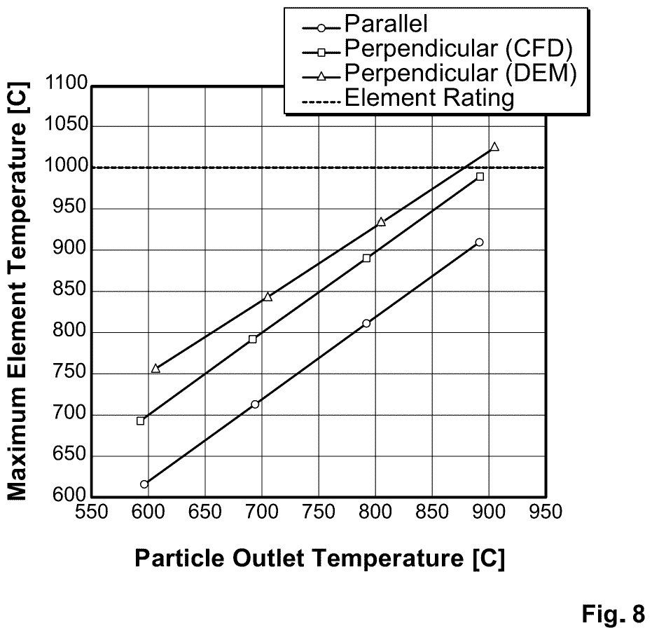

Results for heater element maximum temperature vs particle outlet temperature at a 5 kg/s flow rate are shown for parallel CFD, perpendicular CFD, and perpendicular DEM analyses in FIG. 8. The parallel heater shows an average 10% lower (79° C.) max rod temperature at each outlet temperatures compared to the perpendicular heater configuration (CFD comparison). This result implies that the parallel heater can heat particles to the same temperature as the perpendicular heater while maintaining a peak rod temperature approximately 79° C. lower than that of the perpendicular heater, extending the range of particle temperatures that can be achieved prior to exceeding the elements rated temperature. This result is first due to the removal of the hot “underbelly” associated with heaters in a perpendicular configuration, induced by the wake downstream of the heater element in a cross-flow configuration. The result is second due to improved heat transfer. The parallel heater average heat transfer coefficient ranges from approximately 350-400 W/m²K compared to that of the perpendicular heater which ranges from approximately 120-150 W/m²K and 26-29 W/m²K on the element side and bottom, respectively. These results are presented in FIG. 8.

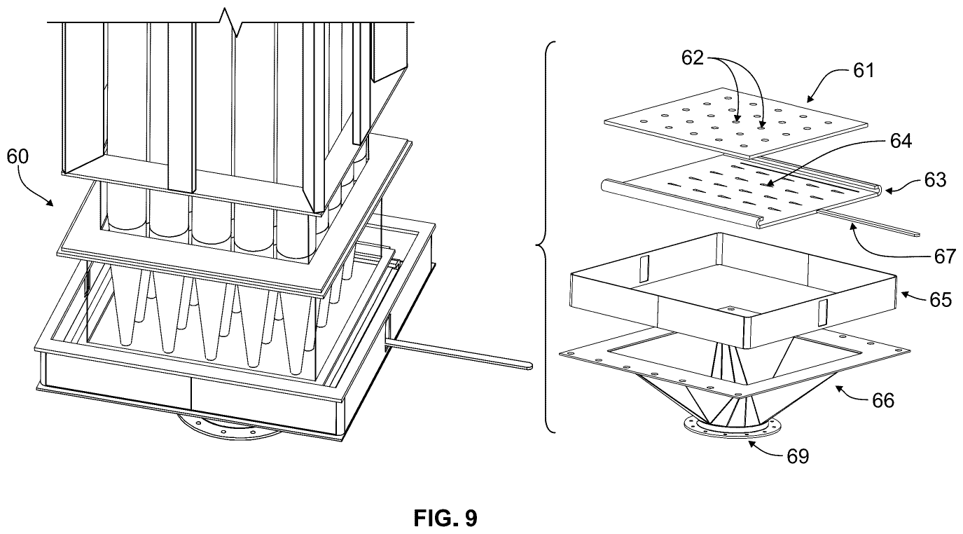

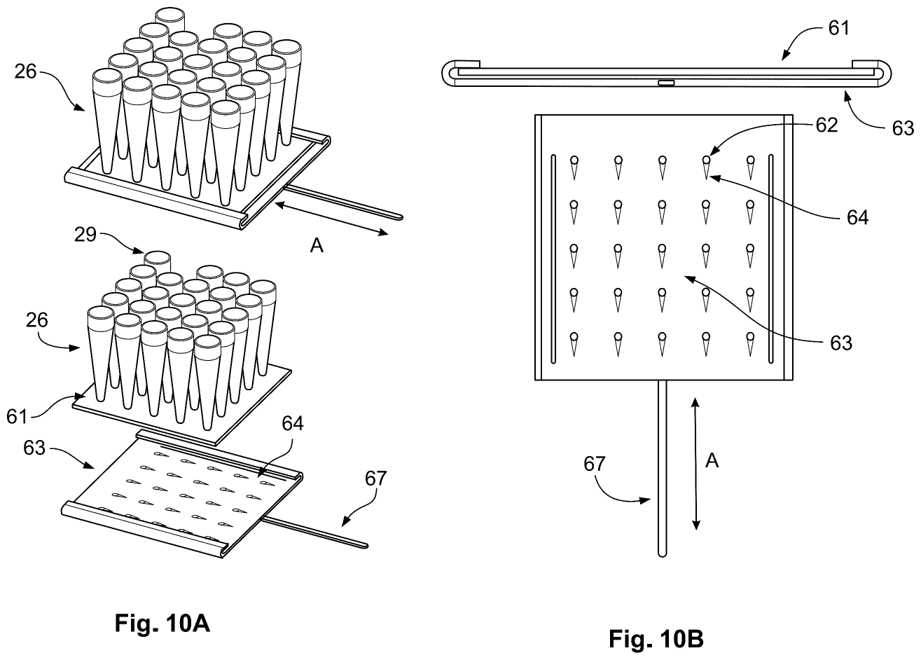

FIG. 9 shows the main components of the particle discharge assembly 60, which includes an outlet tube sheet 61, a slide gate 63, a slide gate housing 65, and a discharge catch 66. The outlet tube sheet 61 (or positioning sheet) includes a plurality of openings 62 to which are connected the discharge openings 28 of the discharge cones 26. The outlet tube sheet secures the discharge cones and maintains alignment of the cone discharge openings 28 with openings 64 in the slide gate 63. The slide gate 63 is positioned adjacent and parallel to the tube sheet 61 and is moveable relative to the discharge tube sheet 61 which allows the openings 64 in the slide gate 63 to be simultaneously moved in relation to the tube sheet openings 62. The movement may be bi-directionally linear (shown as “A” in FIG. 10A). Movement of the slide gate 61 alters the alignment of the respective openings in the tube sheet and slide gate thereby altering particle flow therethrough. Particle flow rate adjustment allows the particle heating system 10 to respond to thermal transient conditions in either the input energy or downstream thermal process. Precise control of particle flow (mass flow rate) through the plurality of annular flow paths is essential for control particle outlet temperature. A uniform mass flow rate through each of the individual particle heaters 20 included in the heater core 50 is critical for optimizing effective use of the heater element units, resulting in the lowest practical cost for heating particles with electricity.

In an embodiment of the disclosure, the conduits 22 are fixedly connected to the inlet tube sheet 44, preferably by welding or other mechanical means. The conduits are permitted to expand freely downward. The discharge cones 26 are fixedly connected to the discharge tube sheet 61 to maintain alignment between the cone discharge openings 28 terminals and slide gate openings 64. The discharge cones 26 are preferably welded to the discharge tube sheet but may be fixed by any equivalent means. The particle heating system 10 is configured to accommodate differential thermal growth between the particle heaters 20 and the surrounding support structure of the particle heating system 10, by an expansion means, including a sliding, telescoping, or other equivalent apparatus in the supporting structure.

The openings 64 in the slide gate 63 may be teardrop shaped to allow for better particle flow rate control as the slide gate, as shown in FIG. 10B. Slide gate movement can be pneumatically or electrically controlled by an actuator positioned outside of the particle discharge system. The slide gate can be hemmed at the sides and used to house the positioning sheet. This way, discharge cones, positioning sheet, and slide gate could displace vertically as one assembled component, due to thermal expansion of the heater tube units. This arrangement provides two main advantages:
Providing perfect alignment between the discharge cones terminals and slide gate openings when operating the heater at high temperature.
Eliminating the need of expensive thermal expansion joints to compensate for thermal expansion/elongation.

The slide gate is equipped with a pulling tab 67 to operably couple the slide gate 63 with the actuator system, whether pneumatic or electric. The pulling tab 67 extends outside of the slide gate housing 65 to achieve the environmental temperature to which the actuator is subjected. The slide gate housing 65 opening though which the pulling tab 67 extends is preferably configured to accommodate vertical thermal displacement of the pulling tab which is connected to the discharge tube sheet.

The final component in the particle discharge assembly 60 is the particle catch 66 which consolidates the individual particle flows passing through the discharge tube sheet/slide gate openings into a single stream of heated particles that may then be directed through the heating system 10 outlet 69 for use in a downstream thermal process.

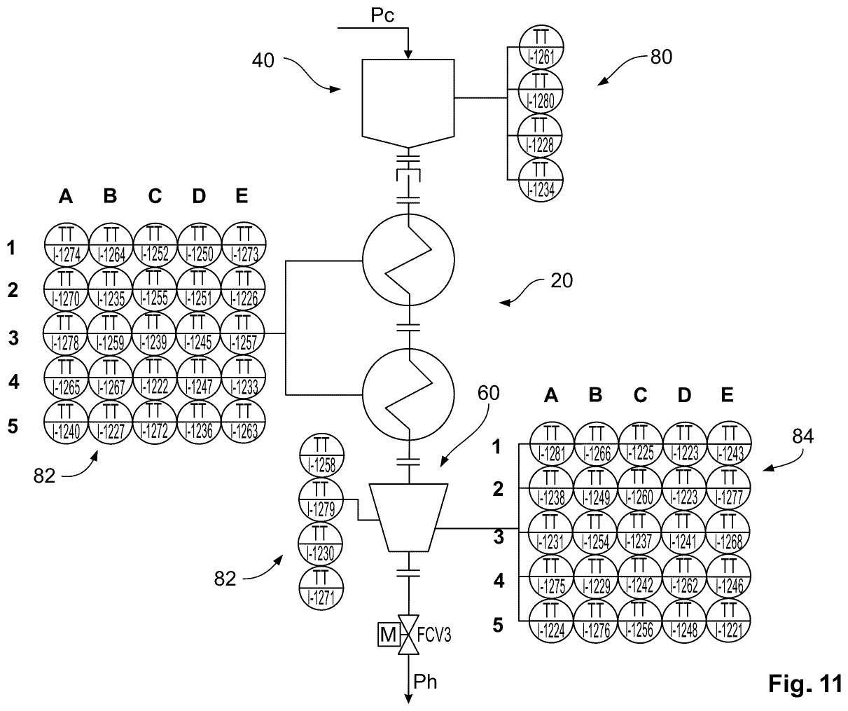

Various heater element control mechanisms may be implemented in the heating system. Each control method is designed to elevate the temperature of incoming particle flow “P_{c}” which may be measured by thermocouples 80 in the particle feeding assembly 40, maintain optimal temperature regulation within the system, and deliver a flow of heated particles Pₕ, as shown in FIG. 11. It is imperative that each control scheme is understood in the context of its application and operational efficacy.

Individual Heater Rod Control—Internal Heating Rod Temperature: Each heater rod within the system is equipped with its own embedded thermocouple sensor 82, allowing for individual temperature measurement and control. This configuration enables precision control, as the heating element(s) in each heating rod can be independently monitored and adjusted. This configuration also ensures the heating rod temperature does not exceed its temperature rating. The heating elements operate on a binary mode, either fully on or off, and are pulsed to maintain the desired temperature setpoint. This approach ensures localized temperature accuracy and can be particularly beneficial in systems requiring differential heating across various segments.

Group Heater Rod Control—Internal Heating Rod Temperature: Alternatively, the system can be configured to utilize a single thermocouple 82 measurement from one heater rod to control all heating rods collectively. In this method, one heating rod's temperature reading dictates the operational status of all heater elements—either on or off—thereby simplifying the control mechanism. This approach might be advantageous for systems where uniform temperature distribution is necessary, and where the variation between different heater rods is minimal or can be statistically managed.

Individual Heater Rod Control—Annular Region Particle Outlet Temperature: Another method described involves using the temperature measurement from thermocouples 84 located as each particle outlet of each annular flow region to individually control the corresponding heater rod for that region. This approach allows for segmented control similar to the individual heater-internal element temperature method described above but is based on the output temperature of each flow region rather than the temperature of the heater rods themselves. It provides a tailored response to the heating needs of each specific segment, ensuring that each the particle flow of the system reaches its target temperature efficiently.

Group Heater Rod Control—Bulk Particle Outlet Temperature: This strategy uses the temperature measurement from thermocouples in the particle outlet, after all flow streams from the annular flow paths have merged, to regulate the operation of all heater rods. This method focuses on the aggregate discharge particle temperature of the system, rather than discharge temperatures from each annular flow path. Control is achieved by turning all heater elements on or off based on the particle outlet temperature, making it a suitable method for applications where end-point temperature uniformity is crucial and variation in annular flow regions is minimal.

Each control method described above offers distinct advantages and can be selected based on specific application requirements. The choice of control strategy should consider factors such as the need for temperature uniformity, response time, system complexity, and cost-effectiveness. The described control strategies can be implemented using the control diagram provided in FIG. 11, indicating temperature measurement locations for the heater inlet, bulk outlet, each flow region outlet, and embedded in elements.

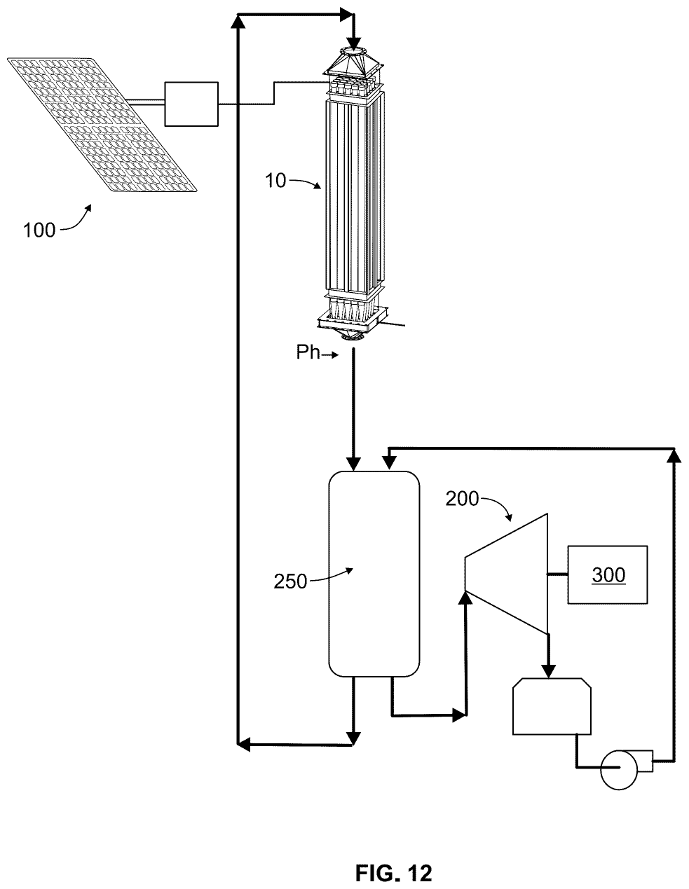

FIG. 12 illustrates an exemplary embodiment of a thermal system according to an embodiment of the disclosure. As can be seen in FIG. 12, the thermal exchange system 250 is located below the heater assembly 10 such that the heated particles are gravity fed to the system 250. In other embodiments, the system 250 may be arranged in various relative positions to the assembly 10 and the particle feed may be by a particle transfer system (not shown) such as, but not limited to conveyors, and bucket lift systems. The vertical heater assembly 10 as described above may be incorporated into a thermal system in which electric input energy needed to power the heating rods is provided as electric current generated from a PV system 100 and transferred to the heated particles Pₕ used in a downstream thermal process 200. A thermal exchange system 250 may transfer heat from the particles to a process fluid used in the downstream thermal process. The downstream thermal process may be concurrent, as driving an electric generator 300 using a steam cycle wherein the thermal exchange system 250 includes a steam generator. The heated solid particles may also dampen fluctuations in input energy from the PV source array to provide a consistent downstream process energy input. The downstream thermal process may also include storage of the heated solid particles for use in a thermal energy conversion process asynchronous with the input energy produced by the PV system. Such thermal energy storage schemes are useful for providing a continuous energy output during times when the PV input is unavailable (i.e., nighttime). The vertical heater assembly 10 may also be useful when the solid particles themselves are the process and particle heating is necessary.

While the exemplary embodiments illustrated in the figures and described herein are presently preferred, it should be understood that these embodiments are offered by way of example only. Accordingly, the present application is not limited to a particular embodiment but extends to various modifications that nevertheless fall within the scope of the appended claims. The order or sequence of any processes or method steps may be varied or re-sequenced according to alternative embodiments.

It is important to note that the construction and arrangement of the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied.

Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

1. An electric particle heater comprising:
an elongate conduit with an inlet and an outlet;
an elongate heating rod disposed within the conduit, an exterior surface of the heating rod being non-contacting with an interior surface of the conduit to define an annular flow path extending between the inlet and the outlet;
a particle feed apparatus configured to deliver a flow of particles to the inlet and distribute the flow of particles in the annular flow path; and
a discharge apparatus configured to receive from the annular flow path the flow of particles gravity-driven through the annular flow path.

2. The heater of claim 1, wherein the elongate heating rod is axially aligned with the annular flow path.

3. The heater of claim 1, wherein the particle feed apparatus is configured to uniformly distribute particles about the inlet of the annular flow path.

4. The heater of claim 1, wherein the discharge apparatus further comprises a conical adapter coupled to the conduit outlet and a flow control apparatus configured to manage particle flow rate through the annular flow path.

5. The heater of claim 4, wherein the coupling of the conical adapter to the outlet enables relative axial movement therebetween.

6. The heater of claim 1, further comprising a heating rod controller configured to manage input energy to the heating rod and maintain the heating rod at a desired temperature.

7. The heater of claim 6, wherein the input energy varied in relation to length of the heating rod by the heating rod controller.

8. A particle heating system comprising:
a particle supply system;
a particle heater arranged to receive particles from the particle supply system, the particle heater further comprising:
a plurality of conduits each having an inlet, an outlet, and a heating rod, each heating rod being disposed within its respective conduit to create an annular flow path axially aligned with the heating rod between the inlet and the outlet;
a particle feed apparatus configured to deliver a flow of particles from the particle supply system to the respective inlets of the plurality of conduits, and to uniformly distribute the flow of particles in the respective annular flow paths of the plurality of conduits; and
a particle discharge apparatus configured to receive and manage the particle flow from the annular flow path; and
a particle discharge system configured to receive heated particles discharged from the plurality of particle discharge apparatus and deliver heated particles to a downstream thermal process.

9. The system of claim 8, wherein each particle discharge apparatus of the plurality of conduits further comprises a conical adapter with a discharge opening.

10. The system of claim 9, wherein the discharge system further comprises a flow control apparatus configured to manage particle flow individually through each of the plurality of annular flow paths.

11. The system of claim 10, wherein the flow control apparatus comprises a slide gate having a plurality of openings disposed adjacent to the plurality of discharge openings of the plurality of conical adapters, movement of the slide gate varying the alignment of the plurality of openings and the plurality of discharge openings and simultaneously alter flow rate of particles through each of the plurality of annular flow paths.

12. The system of claim 8, wherein the particle heater further comprises a heating rod controller configured to manage input energy to each of the plurality of heating rods and maintain each at a desired temperature.

13. The system of claim 12, wherein the input energy may vary in relation to length of the heating rod.

14. The system of claim 12, wherein the input energy is an electric current.

15. A method of heating solid particles for use in a thermal process comprising the steps of:
delivering a flow of particles to a particle heater, the particle heater having a feed apparatus and a plurality of particle heating devices each with a heating rod disposed within a conduit to define an annular flow path extending between an inlet and an outlet;
distributing the flow of particles uniformly about each of the plurality of annular flow paths for gravity-driven flow therethrough;
managing the flow of particles through each of the annular flow paths; and
collecting the flow of particles from the plurality of annular flow paths and deliver the flow of particles to the thermal process.

16. The method of claim 15, wherein each of the particle heating devices further comprises a particle discharge apparatus with a discharge opening, and the particle heater further includes a flow control apparatus configured to manage particle flow individually through each of the plurality of annular flow paths.

17. The method of claim 16, wherein the flow control apparatus includes a moveable slide gate configured to variably and simultaneously obstruct each discharge opening of the plurality of annular flow paths.

18. The method of claim 15, further comprising the step of:
controlling input energy to each heating rod to maintain each heating rod at a desired temperature.

19. The method of claim 18, wherein input energy is varied in relation to length of the heating rod.

20. The method of claim 18, wherein the input energy is an electric current.
